(19) United States
(12) Patent Application Publication
(10) Pub. No.: US 2025/0111623 A1
(43) Pub. Date: Apr. 3, 2025

(54) DISPLAYING APPLICATIONS IN 3D WITHIN AN EXTENDED REALITY ENVIRONMENT

(71) Applicant: Apple Inc., Cupertino, CA (US)

(72) Inventors: Jason M Cahill, Woodinville, WA (US); Brendan J Scully, Cos Cob, CT (US); Christopher J Figueroa, Sunnyvale, CA (US); Earl M Olson, Santa Clara, CA (US); Courtland M Idstrom, Cupertino, CA (US); Seyedkoosha Mirhosseini, Santa Clara, CA (US)

(21) Appl. No.: 18/883,108

(22) Filed: Sep. 12, 2024

Related U.S. Application Data
(60) Provisional application No. 63/541,039, filed on Sep. 28, 2023.

(51) Int. Cl. G06T 19/00; G02B 27/01; G06T 15/00

(52) U.S. Cl. CPC G06T 19/006; G02B 27/017; G06T 15/005

(57) ABSTRACT

Various implementations disclosed herein include devices, systems, and methods that apply a 3-dimensional (3D) effect to content for rendering. For example, a process may obtain content to render within an extended reality (XR) environment. The process may further generate, via a rendering framework, a two-dimensional (2D) rendering of the content The rendering framework generates 3D information based on the content. The process may further generate a 3D effect for rendering the content based on the 3D information. The process may further determine a location of a display region for the content within the XR environment and a view of the XR environment may be presented. Rendering of the content may be presented with the 3D effect at the location in the view of the XR environment.

### CROSS-REFERENCE TO RELATED APPLICATIONS

This Application claims the benefit of U.S. Provisional Application Ser. No. 63/541,039 filed Sep. 28, 2023, which is incorporated herein in its entirety.

### TECHNICAL FIELD

The present disclosure generally relates to systems, methods, and devices that present 3-dimensional (3D) effects for content viewed via electronic devices, such as head-mounted devices (HMDs).

### BACKGROUND

Existing techniques for presenting content via electronic devices may not present 3D elements depicted in such content in desirable ways.

### SUMMARY

Various implementations disclosed herein include devices, systems, and methods that receive content to render within an extended reality (XR) environment. The content for rendering may include a content scene. Content or a content scene may comprise, inter alia, 3-dimensional (3D) content, 2.5-dimensional (2D) content, etc. For example, content may be associated with a video game configured to present renderings of a 3D game environment on a desktop/laptop computer's 2D monitor/display. Content scene may be configured to use a rendering framework such as, inter alia, a hardware accelerated 3D graphic and compute shader application programming interface (API) to present 2D renderings of the content.

Some implementations present 2D renderings of content at a position within a 3D environment, e.g., on a virtual screen positioned in a flat rectangular region within an XR environment presented via an HMD. For example, a computer game application configured to present a 2D view of a game on a 2D display could be presented within an XR environment by presenting that 2D view of the game on a 2D virtual screen within an XR environment, e.g., surrounded by depictions of the physical environment around the user and/or virtual content. In another example, a 2D photograph may be presented within a flat 2D photograph viewing portal within such an XR environment.

Some implementations utilize additional information available for source content that is configured for 2D display on a flat display or flat virtual screen (e.g., a video game or other application, a photograph, other scene content, etc.). Such additional information may be used to enhance the appearance of content by utilizing information that is known about the depth/3D characteristics depicted in the content. For example, a video game that is configured to provide 2D views of a 3D environment may be associated with additional information about that 3D environment that can be used to enhance the appearance of the content. For example, such 3D information may be used to provide 3D effects to the view of the content presented within an XR environment.

In some implementations, a depth-enhanced view of the content is generated by using pre-generated/available 3D information associated with a rendering framework. The pre-generated/available 3D information may include depth information or other 3D information that is used, e.g., within 3D-rendering pipelines configured to generate 2D views of 3D spaces. The pre-generated/available 3D information may include depth information associated with objects within 3D space with respect to a specified viewing perspective. The depth information may be retrieved from a depth buffer such as, inter alia, a Z buffer (e.g., a 2D array of floating point values between zero and one that is used as an aid to ensure proper occlusion in a 3D-rendering pipeline), etc. In some implementations, a depth-enhanced view of the content is additionally generated by using pre-generated/available RGB color information retrieved from an RGB color buffer. In some implementations, a depth-enhanced view of the content is additionally generated by using information retrieved from a geometry buffer such as, inter alia, a G buffer (e.g., textures used to store lighting relevant data).

A depth-enhanced view of the content may be presented via a portal within an XR environment. A portal may comprise a virtual display region to present the content scene within a portion of an XR environment. A depth-enhanced view may be provided by altering the appearance of some or all of the content that is presented at the portal location to generate or hallucinate the appearance of depth. Such a depth-enhanced view may be presented based on a depth information, e.g., 3D information retrieved from a depth buffer such as a Z buffer, an RGB buffer, a geometry buffer such as a G buffer, etc. A system may be configured to present a portal such that portions of a content (e.g., certain portions of content that might otherwise be positioned on the flat surface of the portal) are repositioned. For example, portions of content may be moved off-plane, e.g., pushed into and/or extended from (with respect to a Z direction) a surface of the portal. Such repositioning of virtual content may be employed such that a virtual object (e.g., an automobile, a person, etc.) may appear to be closer to a user view with respect to a background portion (e.g., trees, mountains, etc.) of the content scene.

In some implementations, a depth-enhanced view of the content presented via a portal may be created by providing altered views of the content based on one viewpoint or differing viewpoints, e.g., left and right eye viewpoints provided via an HMD. Providing altered views of the content based on differing viewpoints may provide a parallax type view effect to provide the depth (3D) effect.

In some implementations, the depth-enhanced view of the content presented via a portal may be created by reprojecting each frame of the content for each eye of a user using the 3D information. For example, an application such as a game may generate frames over time that are each presented, e.g., sequentially one after another, and each such frame may be enhanced with an appropriate depth-enhancement.

In some implementations, an HMD has a processor (e.g., one or more processors) that executes instructions stored in a non-transitory computer-readable medium to perform a method. The method performs one or more steps or processes. In some implementations, the HMD obtains content to render within an XR environment. A 2D rendering of the content may be generated, via a rendering framework. The rendering framework may generate 3D information based on the content or otherwise obtain 3D information associated with the content. In some implementations, a 3D effect for the rendering of the content scene based on the 3D information may be generated. In some implementations, a location of a display region for the content may be determined within the XR environment. A view of the XR environment may be presented such that rendering of the content scene is presented with the 3D effect at the location in the view of the XR environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIG. 2A illustrates a first example representing a rendering framework enabled to generate a 3D rendering of 2D rendered content, in accordance with some implementations.

FIG. 2B illustrates a view of an XR environment that includes portal and 3D rendering of 2D rendered content, in accordance with some implementations.

FIG. 3A illustrates a second example representing a rendering framework enabled to generate a 3D rendering of 2D rendered content, in accordance with some implementations.

FIG. 3B illustrates left eye content scene version and right eye left eye content scene version presented within differing views of a portal positioned within an XR environment, in accordance with some implementations.

FIG. 4A is a flowchart representation of an exemplary method that dynamically utilizes 3D information generated via a rendering framework to provide a depth-enhanced 3D view of displayed content at a display portal location within an XR environment, in accordance with some implementations.

FIG. 4B is a flowchart representation of an exemplary method that utilizes 3D information to provide a depth-enhanced view of image content at a portal location in an XR environment, in accordance with some implementations.

FIG. 5 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

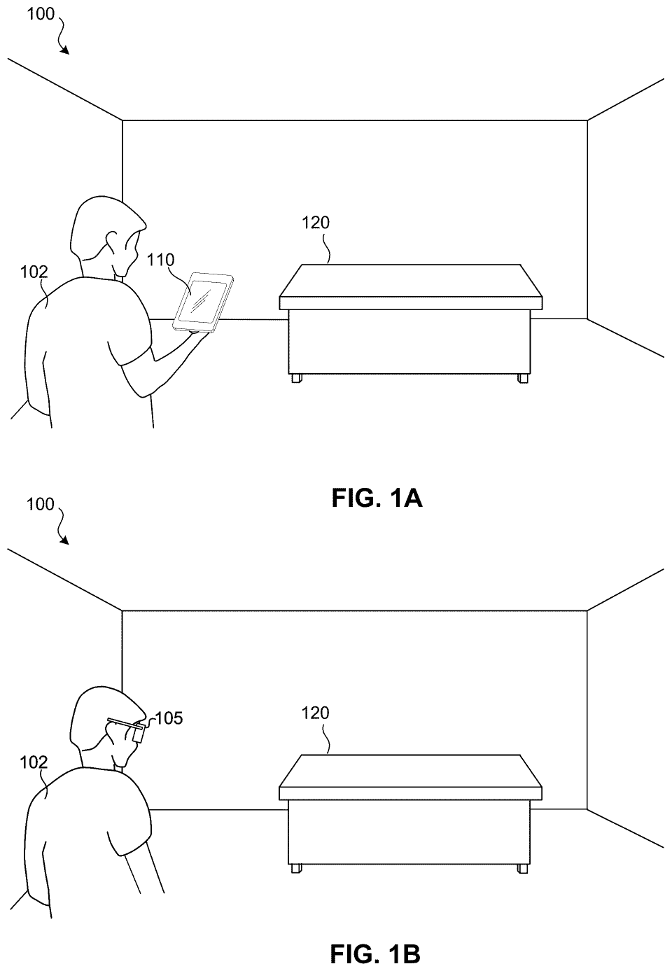

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that are generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an HMD (e.g., device 105), communicatively coupled to a server, or other external device (e.g., a rendering framework) may be configured to obtain content to render within an XR environment. The content may include, inter alia, 3D content or a content scene, 2.5D content or a content scene, etc. 2.5D content comprises a presentation associated with rendered movement within a virtual reality environment that is restricted to a 2D plane with little or no access to a third dimension in a space that appears as a 3D rendering. 3D content comprises a presentation associated with rendered movement within a virtual reality environment that simulates an appearance of being 3D rendered. The content or content scene may be associated with a video game configured to present renderings of a 3D game on a 2D monitor/display of a computer. Alternatively, a content scene may be associated with a video (e.g., a movie) configured to present renderings on a 2D monitor/display of, inter alia, a computer, a television, etc.

In some implementations, a rendering framework may be enabled to generate a 3D rendering of the content or content scene. The rendering framework may be further enabled to generate 3D information based on the content. The 3D information may include depth information associated with objects of the content scene with respect to a specified viewing perspective. The depth information may be retrieved from a depth buffer such as, inter alia, a Z buffer, etc. For example, graphical rendering engines of a rendering framework may generate a depth buffer as a byproduct of rendering a 3D scene to a viewing frustum corresponding to a 2D display of the 3D scene. Likewise, a depth buffer such as a Z buffer, may be generated and utilized by such rendering engines to avoid overdrawing parts of the viewing frustum, where multiple surfaces in the 3D scene may be present at different depths, but only the surface nearest in depth is visible to the viewing frustum.

The 3D information (i.e., a byproduct of a graphical rendering engine such as a depth buffer) may be used to generate a depth-enhanced 3D view of the content or content scene. In some implementations, a depth-enhanced view of the content scene may be additionally generated by using pre-generated/available RGB color information retrieved from an RGB color buffer. An RGB buffer comprises color information that applies various colors to differing portions of a depth-enhanced 3D view of content such that the differing portions of the depth-enhanced 3D view do not comprise a uniformly color viewable from all directions (with respect to depth) resulting in a look of depth accentuated from various perspective views.

In some implementations, a depth-enhanced view of the content scene is additionally generated by using information retrieved from a geometry buffer (e.g., textures used to store lighting relevant data).

The depth-enhanced view of the content may be presented via a portal within an XR environment. A portal may comprise a region within an XR environment at which a content is presented. Repositioning or otherwise altering content displayed via a content portal may be used to generate or hallucinate the appearance of depth based on 3D information. For example, a 3D effect may be generated based on additional 3D information, e.g., depth information retrieved from a depth buffer. For example, a portal may be configured to allow specified pixels of the content to be pushed into the portal (i.e., repositioned to be behind the plane of the portal) such that a virtual object (e.g., an automobile) may appear to be closer to a user view with respect to a background portion depicted by the pixels that are pushed in (e.g., pixels depicting trees, mountains, etc.) of the content. In some implementations, the depth-enhanced view of the content may be formed by placing voxels at different depths with respect to a front surface of the portal.

In some implementations, a depth-enhanced view of the content presented via a portal may be created by providing altered views of the content based on one viewpoint or differing viewpoints, e.g., left and right eye viewpoints provided via an HMD. Providing altered views of the content scene based on differing viewpoints may provide a parallax type view effect to provide the depth (3D) effect.

In some implementations, the depth-enhanced view of the content scene presented via a portal may be created by reprojecting each frame of the content for each eye of a user using the 3D information. For example, an application such as a game may generate frames over time that are each presented, e.g., sequentially one after another, and each such frame may be enhanced with an appropriate depth-enhancement.

In some implementations, an HMD (e.g., device 105), communicatively coupled to a server, or other external device (e.g., a rendering framework) may be configured to receive 2D content to render within an XR environment. The 2D content may be generated using 3D information. For example, the 2D content may be generated via usage of depth information associated with objects in 3D space with respect to a particular perspective. The depth information may be obtained from a depth buffer such as, inter alia, a Z buffer. Depth information may be generated for each frame of the 2D content. The 3D information may be used to provide a depth-enhanced view of the 2D content at a portal (display) location within the XR environment. For example, a depth-enhanced view of the 2D content may be generated by utilizing parallax processes to modify the 2D content based on a user viewpoint and the 3D information. In some implementations, a user may attempt to view the depth-enhanced 2D content with respect to an off-axis perspective (e.g., a 15 degree offset perspective with respect to a center axis in front of the user) and therefore, an off-axis mitigation process may be may be implemented to mitigate off-axis viewing effects. For example, parallax effects (e.g., an amount of depth effect) may be reduced as a user perspective moves away a center axis. Likewise, a relighting process may be enabled (to mitigate off-axis viewing effects) using normal maps obtained from, inter alia, a geometry buffer such as a G-buffer and/or surface type labels associated with properties such as specular, metallic, etc.

Alternatively, a depth-enhanced view of the 2D content may be generated by creating stereo disparity by reprojecting differing views for a left eye and right eye based on the 3D information. For example, rendered 2D content may be used as an initial rendered viewpoint for a first eye of a user and subsequently, the rendered 2D content may be reprojected to a second eye of the user. Alternatively, rendered 2D content may be used as a center point and subsequently, the rendered 2D content may be independently reprojected to a right eye and a left eye of user. Reprojecting the differing views enables projected content to be modified while a user's head remains in a static position.

During a process for reprojecting differing views, a low-resolution and low-frequency mesh (for depth modeling) may be generated. The low-resolution/low-frequency mesh is configured to snap to depth buffer pixel depth information. For example, low-resolution/low-frequency mesh may be generated such that it uses a granularity that comprises a lower resolution that snaps to consistent portions of Z depth.

Generating left and right eye viewpoints (at differing angles) may result in projections that include holes that may be filled to enhance viewing of a depth-enhanced view (3D) of 2D content. Therefore, a process for filling the holes may be implemented such that texture edges are stretched at depth discontinuities associated with adjacent pixels. Likewise, holes may be filled with data obtained from multiple frames of the content. Alternatively, holes may be filled by using an inpainting process with respect to a background of the content.

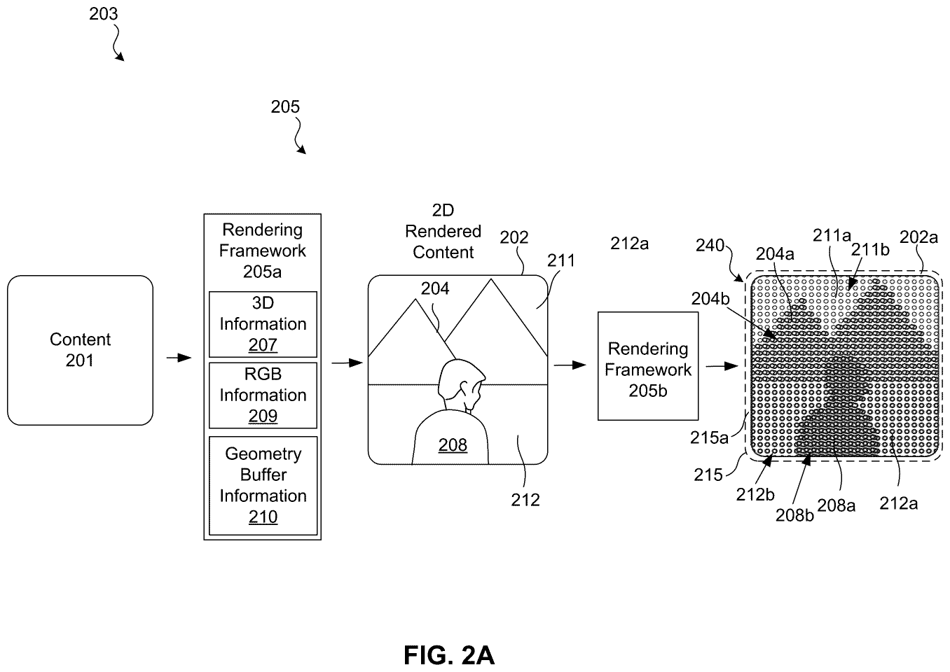

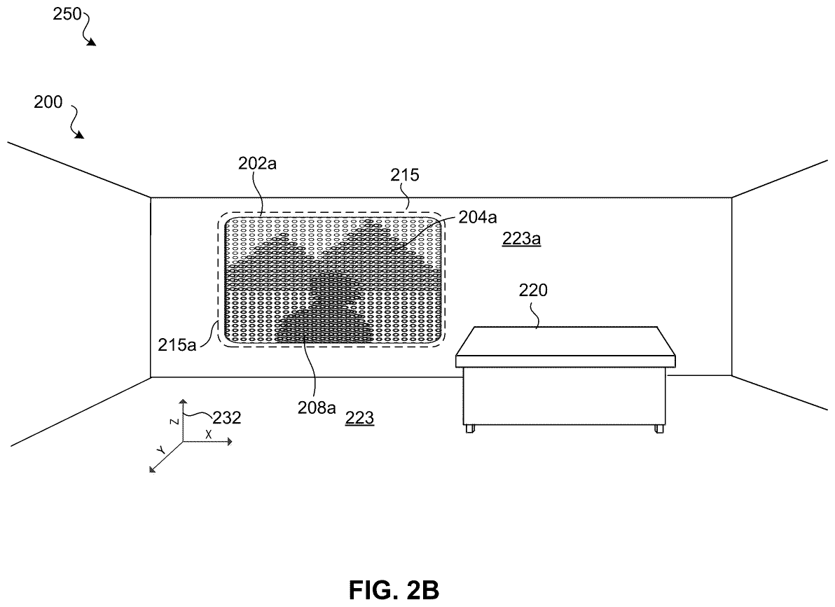

FIG. 2A illustrates an example 203 representing a rendering framework 205 enabled to generate a 3D rendering 202a of 2D rendered content (or content scene) 202, in accordance with some implementations. Rendering framework portion 205a (of rendering framework 205) is configured to initially obtain content 201 for rendering within, inter alia, an XR environment. Initial inputted content 201 may be associated with a video game or software application configured to present views of 3D video on a 2D monitor/display of a computer. The content 201 may include a content scene(s). Content 201 may include, inter alia, 2.5D content, 3D content, etc. 2D rendered content 202 illustrated in FIG. 2A comprises a 2D rendered presentation 208 of a person in a foreground, a 2D rendered presentation 212 of a landscape in a background, a 2D rendered presentation 204 of mountains further in a background, and a 2D rendered presentation 211 of a horizon further in a background.

The process for generating 3D rendering 202a of 2D rendered content 202 may include a two-step process that enables rendering framework portion 205a to initially obtain content 201 and generate 2D rendered content 202. During the process for generating 2D rendered content 202, information such as 3D information 207, RGB information 209, and/or geometry buffer information 210 may be generated based on the initial content. 3D information 207, RGB information 209, and geometry buffer information 210 may be initially generated to create realistic 2D content for rendering. 2D rendered content 202 may be a viewing frustum of 3D content within a field of view with respect to a desired camera perspective.

3D information 207 may comprise information retrieved from a depth buffer. A depth buffer such as, inter alia, a Z buffer may include information used to enable accurate and realistic viewing of a content scene that includes hidden surfaces such as objects within a view that may be located behind additional objects located within a user view (e.g., closer to a user view). For example, during content scene rendering each pixel of a content scene is associated with x, y, and z coordinates. A depth buffer such as a Z buffer comprises a two-dimensional array (x and y coordinates) that stores a Z-value for each pixel such that if multiple objects are to be rendered at a same pixel location, the Z buffer may override a previous value if a subsequent pixel determined to be closer to a camera/view. Therefore, a depth buffer (a Z buffer) is configured to compare surface depths of a content scene with respect to each pixel position on a projection plane (a Z plane) associated with the content scene.

RGB information 209 may comprise color information retrieved from an RGB-buffer.

Geometry buffer information 210 may comprise information associated with a rendering process executed with respect to two sequential passes. During a first geometry pass, a scene is rendered once and geometric information from objects within the rendering is retrieved and stored as a collection of textures within a geometry buffer. For example, the geometric information may comprise, inter alia, position vectors, color vectors, normal vectors, specular values, etc. The geometric information stored in the G-buffer may be used for subsequent lighting calculations during a second pass.

Subsequently, rendering framework portion 205b re-uses 3D information 207, RGB information 209, and/or geometry buffer information 210 (already generated to create 2D rendered content scene 202) to generate 3D rendering 202a of 2D rendered content scene 202. In a sense, a graphics processing unit (GPU) pipeline may be executed to operate in a reverse direction (e.g., with respect to typical operation) to re-use a byproduct (e.g., 3D information 207, RGB information 209, and/or geometry buffer information 210) of the initial process for generating 2D rendered content scene 202 such that the byproduct is used to recreate a geometry for generating a 3D effect for rendering. The 3D rendering 202a comprises a depth-enhanced view of content at a portal 215 within an XR environment (e.g., as illustrated in FIG. 2B, infra) by, for example, creating depth using a parallax view type effect.

The 3D rendering 202a may be generated by using 3D information 207, RGB information 209, and/or geometry buffer information 210 to create depth (i.e., a 3D effect) by extruding voxels 240 (e.g., 3D pixels) with respect to different depths relative to a front/top surface 215a of portal 215. For example, 3D rendering 202a may be generated by placing voxels 240 at different depths extending into a front/top surface 215a of portal 215 and/or into an XR environment from a front/top surface 215a of portal 215.

3D rendering 202a comprises: a rendered 3D presentation 208a of a person in a foreground at a first depth represented by extruded voxels 208b, a rendered 3D presentation 212a of a landscape in a background at a second depth represented by extruded voxels 212b, a rendered 3D presentation 204a of mountains further in a background at a third depth represented by extruded voxels 212b, and a rendered 3D presentation 211a of a horizon further in a background at a fourth depth represented by extruded voxels 211b.

FIG. 2B illustrates a view 250 of an XR environment including a physical environment 200 that includes a room 223 and a desk 220 and a virtual environment that includes portal 215 and 3D rendering 202a of 2D rendered content as illustrated with respect to FIG. 2A, in accordance with some implementations. 3D rendering 202a comprises a depth-enhanced view of content at portal 215 within the XR environment by, for example, creating depth using parallax.

Portal 215 may be a user interface (UI), comprising a display, formed by creating an opening (with respect to a Z direction 232) within, e.g., a back wall 223a of a room 223. Portal 215 is configured to present 3D rendering 202a within the portal 215 to create depth (i.e., a 3D effect) based on a depth information retrieved from e.g., a depth buffer, an RGB buffer, a geometry buffer, etc. For example, portal 215 may be configured to allow a content scene (e.g., voxels) to be pushed into and/or extend from (in a Z direction 232) surface 215a of portal 215 such that a virtual object (e.g., rendered 3D presentation 208a) may appear to be closer to a user view with respect to a background portion (e.g., rendered 3D presentation 204a) of the content.

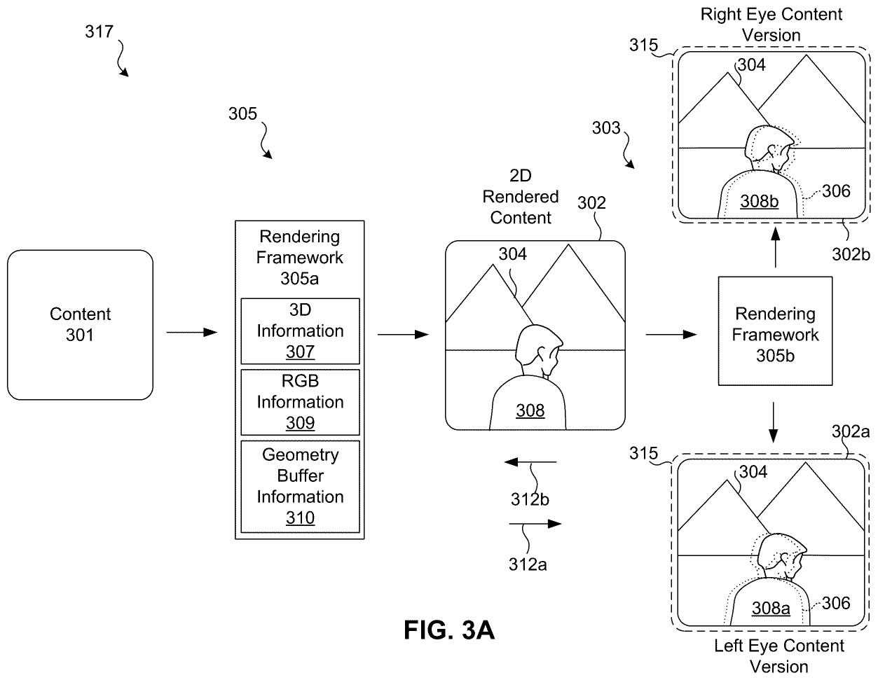

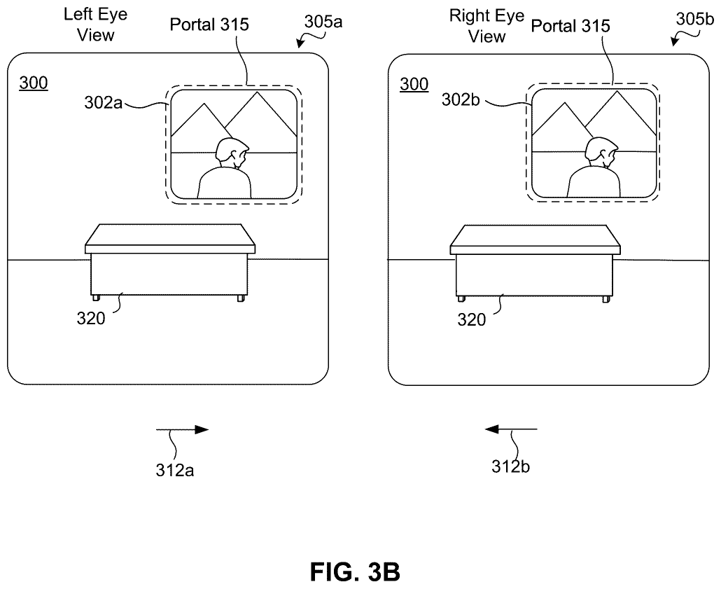

FIG. 3A illustrates an example 317 representing a rendering framework 305 enabled to generate a 3D rendering 303 (including left eye content version 302a and a right eye content version 302b) of 2D rendered content 302, in accordance with some implementations. Rendering framework portion 305a (of rendering framework 305) is configured to initially obtain content 301 for rendering within, inter alia, an XR environment. The content 201 may be associated with a video game or software application configured to present views of 3D video on a 2D monitor/display of a computer. The content may include a content scene(s). Content 301 may include, inter alia, 2.5D content, 3D content, etc. 2D rendered content 302 illustrated in FIG. 3A comprises a 2D rendered presentation 308 of a person in a foreground and a 2D rendered presentation 304 of mountains in a background.

The process for generating 3D rendering 303 of 2D rendered content 302 may include a two-step process that enables rendering framework portion 305a to initially obtain content 301 and generate 2D rendered content 302. During the process for generating 2D rendered content 302, information such as 3D information 307, RGB information 309, and/or geometry buffer information 310 may be generated based on the initial content 301. 3D information 307 (e.g., from a Z buffer), RGB information 309, and geometry buffer information 310 may be initially generated to create realistic 2D content for rendering.

Subsequently, rendering framework portion 305b re-uses 3D information 307, RGB information 309, and/or geometry buffer information 310 to generate 3D rendering 303 of 2D rendered content scene 302. The 3D rendering 303 comprises a depth-enhanced view of content within a portal 315 within an XR environment (e.g., as illustrated in FIG. 3B, infra) by, for example, reprojecting the 2D rendered content 302 and/or portal 315 for each eye to generate left and right viewpoints using 3D information 307, RGB information 309, and/or geometry buffer information 310.

A reprojection process may include, inter alia, altering 2D rendered content 302 by providing (for a user to view via, e.g., an HMD) left eye content version 302a and right eye content version 302b (of 2D rendered content 302). The left eye content version 302a represents a view 308a (e.g., a first viewpoint) of 2D rendered presentation 308 located at a first position (e.g., shifted horizontally in a direction 312a) differing from an original position 306 of 2D rendered presentation 308 in 2D rendered content 302. The right-eye content version 302b represents a view 308b (a second differing viewpoint) of 2D rendered presentation 308 located at a second position (e.g., shifted horizontally in a direction 212b) differing from the original position 306 of 2D rendered presentation 308 in 2D rendered content scene 302. The first position represents 2D rendered presentation 308 at a different location within left eye content version 302a than the second position within right eye content version 302b. Therefore, when viewed via an HMD, the combination of left eye content version 302a and right eye content version 302b are presented (to a user) as merged content representing a 3D effect with respect to 2D rendered presentation 308.

FIG. 3B illustrates left eye content scene version 302a and right eye left eye content scene version 302a of FIG. 3A presented within differing views of portal 315 positioned within an XR environment 300, in accordance with some implementations. XR environment 300 includes a physical environment (e.g., physical environment 100 of FIG. 1) comprising a desk 320 and portal 315.

In FIG. 3B, a 3D effect (generated based on 3D information retrieved from e.g., a depth buffer, an RGB buffer, a geometry buffer, etc.) is applied to portal 315 comprising the left eye content version 302a and right eye left eye content version 302a by providing (for the user to view via, e.g., an HMD) a left eye view 305a and a right eye view 305b (of portal 315). The left eye view 305a represents a view of portal 315 located at a first position (e.g., shifted horizontally in a direction 312a). The right eye view 305b represents a view of portal 315 located at a second position (e.g., shifted horizontally in a direction 312b) differing from the first position of portal 315 presented in left eye view 305a. The differing positions of the left eye view 305a and the right eye view 305b enable the user to view (when viewed via an HMD) a combination of left eye view 305a and the right eye view 305b as a portal view representing a 3D effect with respect to portal 315 and/or 2D rendered presentation 308. Each of the processes described with respect to FIGS. 3A and 3B may be performed independently or in combination to generate the 3D effect.

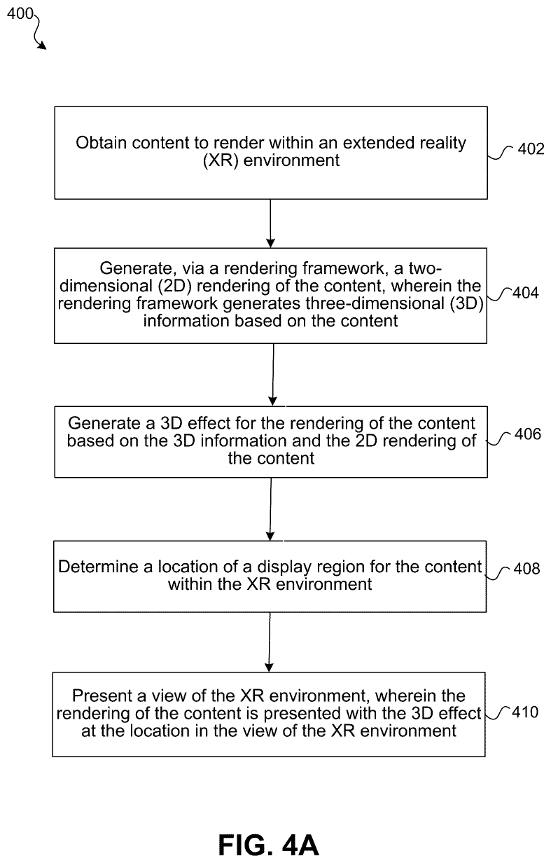

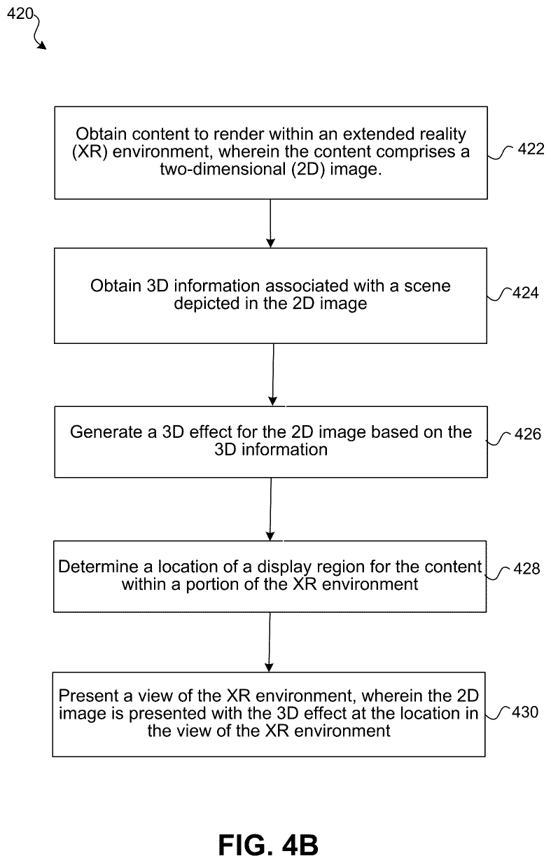

FIG. 4A is a flowchart representation of an exemplary method 400 that dynamically utilizes 3D information generated via a rendering framework to provide a depth-enhanced 3D view of displayed content at a display portal location within an XR environment, in accordance with some implementations. In some implementations, the method 400 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 obtains content to render within an extended reality (XR) environment. The content may include, inter alia, 3D content, 2.5D content, etc. For example, the content may be associated with a video game or software application configured to present views of a 3D environment on a 2D monitor/display of a computer.

At block 404, the method 400 generates, via a rendering framework, a 2D rendering of the content. The rendering framework may be configured to generate 3D information based on the content. The 3D information may include depth information received from a depth buffer such as, inter alia, a Z-buffer. The depth information may be used by the rendering framework to render a 3D scene to a viewing frustum corresponding to the 2D rendering. Likewise, the 3D information may include information obtained from, inter alia, an RGB buffer, a geometry buffer, etc. Information obtained from an RGB buffer may include color information used by the rendering framework to apply various colors to differing portions associated with differing depth-enhanced views of the content presented with the 3D effect. Information obtained from a geometry buffer may include depth information used by the rendering framework to generate lighting effects within the 2D rendering of the content.

At block 406, the method 400 generates a 3D effect for rendering the content scene based on the 3D information and the 2D rendering of the content.

At block 408, the method 400 determines a location of a display region for the content. The display location may be located within a portion of the XR environment. The display region comprises may comprise a size that is less than the entire XR environment. The display region for the content may comprise a portal structure formed within the portion of the XR environment. The portal structure may comprise a rectangular, circular, or window type display region within the XR environment.

At block 410, the method 400 presents a view of the XR environment. In some implementations, the content is rendered with the 3D effect at the location of the display region. In some implementations, the display region for the content is a portal structure formed within the portion of the XR environment. In some implementations, the content with the 3D effect may be presented within the portal structure.

In some implementations, the portal structure may be formed from a plurality of portals each placed with respect to a differing point of a view of a user such that the portal structure comprises a non-planar structure such as a curved structure, a tilted structure, etc. Therefore, depth values from the depth buffer are configured to be manipulated with respect to a non-planar baseline.

In some implementations, the portal structure may be formed from a plurality of portals within a simulated environment such as a virtual environment, an XR environment, etc. For example, the portal structure may be formed from a plurality of portals each placed within a differing location within a simulated room. Likewise, the portal structure may be formed from a plurality of portals each placed within a differing location within a simulated vehicle associated with a driving simulation. For example, the plurality of portals may comprise, inter alia, a windshield portal, a driver window portal, a passenger window portal, etc.

In some implementations, the content scene presented with the 3D effect may be formed by placing voxels at different depths within the portal structure with respect to a front surface of the portal structure.

In some implementations, the content scene presented with the 3D effect may be formed by placing voxels at different depths extending into the XR environment from a front surface of the portal structure.

In some implementations, the content scene presented with the 3D effect may be formed by placing voxels at different depths within the portal structure and at different depths extending into the XR environment from the front surface of the portal structure.

In some implementations, the content scene presented with the 3D effect may be formed by reprojecting each frame of the content scene for each eye of a user using the 3D information.

In some implementations, rendering of content scene presented with the 3D effect may provide a depth-enhanced view of the content scene within the portal structure.

In some implementations, the 3D effect is provided by providing altered views of the image based on differing viewpoints within the portal structure to provide a parallax effect.

FIG. 4B is a flowchart representation of an exemplary method 420 that utilizes 3D information to provide a depth-enhanced view of image content at a portal location in an XR environment, in accordance with some implementations. In some implementations, the method 420 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 420 is performed by processing logic, including hardware, firmware, software, or a combination thereof. In some implementations, the method 420 is performed by a processor executing code stored in a non-transitory computer-readable medium (e.g., a memory). Each of the blocks in the method 420 may be enabled and executed in any order.

At block 422, the method 420 obtains content to render within an extended reality (XR) environment. The content may comprise a two-dimensional (2D) image.

At block 424, the method 420 obtains 3D information associated with a scene depicted in the 2D image. In some implementations, the 3D information may be obtained by hallucinating a depth buffer based on depth sensor data used to create the 2D image during capture. The depth sensor data may be stored within metadata of the 2D image.

At block 426, the method 420 generates a 3D effect for the 2D image based on the 3D information.

At block 428, the method 420 determines a location of a display region for the content within a portion of the XR environment. In some implementations, the display region for the content may include a portal structure formed within the portion of the XR environment. The 2D image may be presented with the 3D effect within the portal structure.

In some implementations, the portal structure may be formed from a plurality of portals each placed with respect to a differing point of view of a user such that the portal structure comprises a non-planar display structure such as, inter alia, a curved display structure, a tilted display structure, etc.

At block 430, the method 420 presents a view of the XR environment. In some implementations, the 2D image is presented with the 3D effect at the location in the view of the XR environment.

In some implementations, the 2D image presented with the 3D effect may be formed by placing voxels at different depths within the portal structure with respect to a front surface of the portal structure.

In some implementations, the 2D image presented with the 3D effect may be formed by reprojecting the 2D image for each eye of a user using the 3D information.

In some implementations, the 2D image presented with the 3D effect may provide a depth-enhanced view of the 2D image within the portal structure.

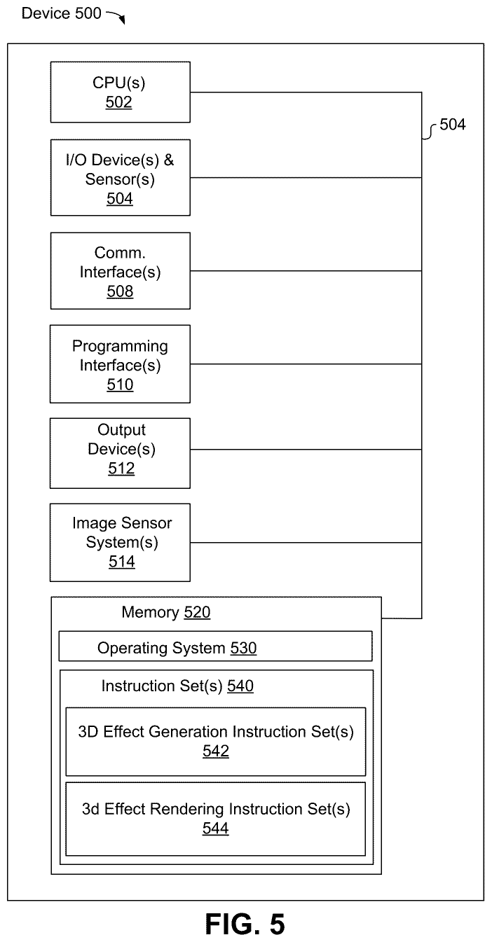

FIG. 5 is a block diagram of an example device 500. Device 500 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a 3D effect application instruction set 542 and a 3D effect presentation instruction set 544. The instruction set(s) 540 may be embodied as a single software executable or multiple software executables.

The 3D effect application instruction set 542 is configured with instructions executable by a processor to determine to generate and apply a 3D effect for rendering a content scene, such as a video game or movie scene, based on 3D information retrieved from a depth buffer (e.g., a Z buffer).

The 3D effect rendering instruction set 544 is configured with instructions executable by a processor to present a view of an XR environment such that a content scene is presented with a 3D/depth effect within a portal location within a view of the XR environment.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head mounted device (HMD) having a processor and a display:
obtaining content to render within an extended reality (XR) environment;
generating, via a rendering framework, a two-dimensional (2D) rendering of the content, wherein the rendering framework generates three-dimensional (3D) information based on the content;
generating a 3D effect for the rendering of the content based on the 3D information;
determining a location of a display region for the content within the XR environment; and
presenting a view of the XR environment, wherein the rendering of the content is presented with the 3D effect at the location in the view of the XR environment.

2. The method of claim 1, wherein the content is 3D content.

3. The method of claim 1, wherein the content is 2.5D content.

4. The method of claim 1, wherein the 3D information comprises depth information, obtained from a depth buffer, used by the rendering framework to render a 3D scene to a viewing frustum corresponding to the 2D rendering.

5. The method of claim 1, wherein the 3D information comprises color information, obtained from an RGB buffer, used by the rendering framework to apply various colors to differing portions associated with differing depth-enhanced views of the content presented with the 3D effect.

6. The method of claim 1, wherein the 3D information comprises depth information, obtained from a geometry buffer, used by the rendering framework to generate lighting effects within the 2D rendering of the content.

7. The method of claim 1, wherein the display region for the content comprises a portal structure formed within a portion of the XR environment, and wherein the rendering of the content presented with the 3D effect is presented within the portal structure.

8. The method of claim 7, wherein the portal structure is formed from a plurality of portals each placed with respect to a differing point of view of a user such that the portal structure comprises a non-planar structure.

9. The method of claim 7, wherein the content scene presented with the 3D effect is formed by placing voxels at different depths within the portal structure with respect to a front surface of the portal structure.

10. The method of claim 7, wherein the content presented with the 3D effect is formed by placing voxels at different depths extending into the XR environment from a front surface of the portal structure.

11. The method of claim 7, wherein the content scene presented with the 3D effect is formed by placing voxels at different depths within the portal structure and at different depths extending into the XR environment from the front surface of the portal structure.

12. The method of claim 7, wherein the content scene presented with the 3D effect is formed by reprojecting each frame of the content for each eye of a user using the 3D information.

13. The method of claim 7, wherein the rendering of the content presented with the 3D effect provides a depth-enhanced view of the content within the portal structure.

14. The method of claim 13, wherein the 3D effect is provided by providing altered views of the image based on differing viewpoints within the portal structure to provide a parallax effect.

15. A head mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the HMD device to perform operations comprising:
obtaining content to render within an extended reality (XR) environment;
generating, via a rendering framework, a two-dimensional (2D) rendering of the content, wherein the rendering framework generates three-dimensional (3D) information based on the content;
generating a 3D effect for the rendering of the content based on the 3D information;
determining a location of a display region for the content within the XR environment; and
presenting a view of the XR environment, wherein the rendering of the content scene is presented with the 3D effect at the location in the view of the XR environment.

16. The HMD of claim 15, wherein the content is 3D content.

17. The HMD of claim 15, wherein the content is 2.5D content.

18. The HMD of claim 15, wherein the 3D information comprises depth information, obtained from a depth buffer, used by the rendering framework to render a 3D scene to a viewing frustum corresponding to the 2D rendering.

19. The HMD of claim 15, wherein the 3D information comprises color information, obtained from an RGB buffer, used by the rendering framework to apply various colors to differing portions associated with differing depth-enhanced views of the content presented with the 3D effect.

20. The HMD of claim 15, wherein the 3D information comprises depth information, obtained from a geometry buffer, used by the rendering framework to generate lighting effects within the 2D rendering of the content.

21. The HMD of claim 15, wherein the display region for the content comprises a portal structure formed within a portion of the XR environment, and wherein the rendering of the content presented with the 3D effect is presented within the portal structure.

22. The HMD of claim 21, wherein the portal structure is formed from a plurality of portals each placed with respect to a differing point of view of a user such that the portal structure comprises a non-planar structure.

23. The HMD of claim 21, wherein the content presented with the 3D effect is formed by placing voxels at different depths within the portal structure with respect to a front surface of the portal structure.

24. The HMD of claim 21, wherein the content presented with the 3D effect is formed by placing voxels at different depths extending into the XR environment from a front surface of the portal structure.

25. A non-transitory computer-readable storage medium storing program instructions executable via one or more processors, of a head mounted device (HMD) electronic device, to perform operations comprising:
obtaining content to render within an extended reality (XR) environment;
generating, via a rendering framework, a two-dimensional (2D) rendering of the content, wherein the rendering framework generates three-dimensional (3D) information based on the content;
generating a 3D effect for the rendering of the content based on the 3D information;
determining a location of a display region for the content within the XR environment; and
presenting a view of the XR environment, wherein the rendering of the content scene is presented with the 3D effect at the location in the view of the XR environment.
